(19) United States
(12) Patent Application Publication
(10) Pub. No.: US 2010/0318215 A1
(43) Pub. Date: Dec. 16, 2010

(54) DEVICE AND METHOD FOR CONTROLLING THE TRANSPORTATION OF AN OBJECT TO A RECEIVING UNIT

(75) Inventors: Karl-Heinz Bentele, Tettnang (DE); Dietmar Kade, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/814,606

(22) Filed: Jun. 14, 2010

(30) Foreign Application Priority Data
Jun. 12, 2009 (DE) 10 2009 024 746.7

(51) Int. Cl. G06F 7/00

(52) U.S. Cl. 700/215

(57) ABSTRACT

A device and a method for controlling the transportation of an object, particularly a mail article to a receiving unit. The device includes an image recording device, a reader, a computer-available allocation table and a data-processing device with an output device and an input device. The image recording device generates a computer-available image. The reader decodes the receiver identification by using the image from the image recording device. The allocation table has in each case one record with an identification of the receiver for a set of possible receivers and a code of a receiving unit for an object. The data-processing device selects a record in the allocation table by using a decoding result from the reader and outputs the receiving unit code of this record on the output device in a form perceptible by a person. During this process, a computer-available selection list is generated, the selection list including each receiver identification of an identified record.

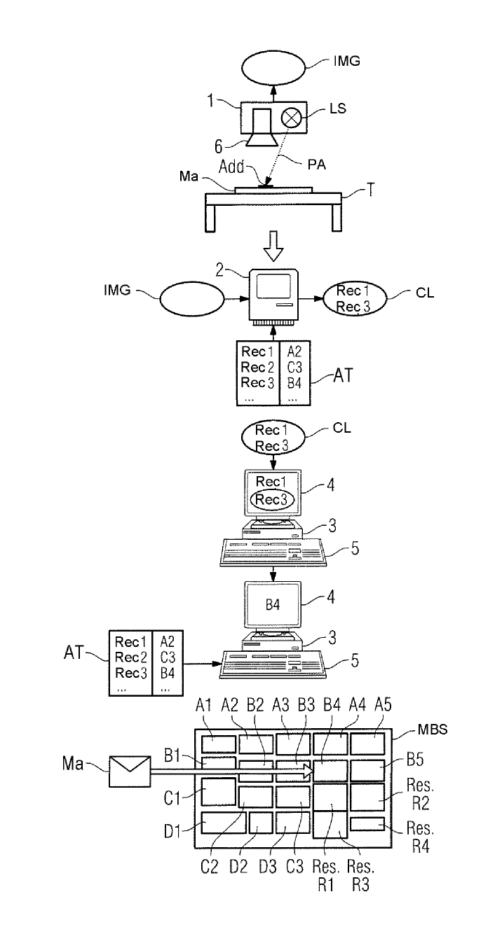

### CROSS-REFERENCE TO RELATED APPLICATION

This application claims the priority, under 35 U.S.C. §119, of German patent application DE 10 2009 024 746.7, filed Jun. 12, 2009; the prior application is herewith incorporated by reference in its entirety.

### BACKGROUND OF THE INVENTION

### Field of the Invention

The invention relates to a device and a method for controlling the transportation of an object, particularly a mail article, to a receiving unit.

The object to be controlled is provided with an identification of a receiver of the object and the device comprises: a computer-available allocation table, a data-processing device having an output device, an image recording device and a reader. The allocation table comprises in each case one record with an identification of the receiver for a set of possible receivers, and each record of the allocation table additionally includes a code of a receiving unit for an object. The image recording device is configured to generate a computer-available image in such a manner that the image shows the receiver identification. The reader is arranged for decoding the receiver identification on an object automatically by using an image from the image recording device. The data-processing device is configured to select a record of the allocation table automatically, in the selection of this record of the allocation table, using a decoding result from the reader and outputting an entry of this selected record on the output device in a form that can be perceived by a person. The entry output identifies the receiving unit, the code of which is composed of the selected record.

A device of that type is described in U.S. Pat. No. 6,370,446. There, there is described a device that assists an operator in sorting mail articles 3 into a sorting compartment arrangement, e.g. into a storage frame 4 having many compartments (“pigeon holes”). Each compartment of the storage frame 4 is provided with an electrical indicator means 40A which is mounted in a holder 400A. An optical reader terminal 5 has an opto-electronic read and recognition means 50 and an optical reader and recognition device 8, the latter being capable of processing documents up to A4 size. The optical reader terminal 5 has a memory with a database 52 in which records with possible receivers of mail articles within a company are stored. Each record contains information on in each case one possible receiver and an associated compartment in the storage frame 4. In operation, the optical reader and recognition device 8 reads an address on a mail article 3 and determines the associated compartment in the storage frame 4. The optical reader terminal 5 transmits a corresponding message to the storage frame 4. The indicator means 40A of the compartment which is named in the message from the optical reader terminal 5 lights up and indicates the correct compartment to a user.

European published patent application EP 1 659 523 A1 describes a method for further processing mail articles which arrive in a company and are processed in a mail room of the company. Each mail article is provided with information relating to a receiver, e.g. a natural person and/or a department of the company. In an internal database of the company, address information relating to the receiver of the company and senders who send following mail articles to this company are stored. A sorting system has a feed device 102 and a reader with an image recording device 112. An OCR unit 116 evaluates images from the image recording device 112 in order to decode addresses. Each mail article is brought into a sort bin in dependence on the reading result. For this purpose, the sorting system uses a sort scheme which is stored in a sort scheme database 126. A reader database 120 contains possible destination addresses in the company. The OCR unit 116 evaluates this address database 120. It can vary from company to company how the address database 120 is structured. In EP 1659523 A1, it is described how the address database 120 is filled with records.

German patent DE 10 2007 034 660 B3 describes a method for sorting objects according to a feature, for example, mail articles according to their destination addresses. Mail articles having different destination addresses are passed out into the same output container. To be able to distinguish these mail articles from one another, the sorting system labels separating elements. On each separating element, a destination address and the number of mail articles having this destination address is entered.

German published patent application DE 10 2008 017 140 A1—which was published subsequently to the priority date of the instant application—describes a method and a device for sorting objects are described. Each object which is, e.g., a mail article, is provided with an identification of the receiver of the object. The objects are sorted by means of a sorting system. This sorting system carries out at least one, preferably several sorting runs. In each sorting run, the sorting system uses a sort scheme. This sort scheme allocates an output container of the sorting system to each possible destination area. A destination area comprises several possible destination addresses.

The sorting system has an image recording device which in each case generates one image of each mail article, and a reading device which evaluates the image and reads the destination address in the image. If this is not successful, the image is forwarded to a video coding station and an operator enters the destination address at least partially. The sorting system passes each mail article into an output container in dependence on its respective destination address and on the sort scheme. As a result, mail articles reach different destination areas in the same output container. These mail articles in an output container are separated by separating elements. An identification of the destination area and the number of mail articles for this destination area are printed onto each separating element.

United States patent application publication US 2009/0223877 A1 describes a sorting system for mail articles. A reader decodes the respective address on a mail article. The sorting system sorts each mail article in such a manner that stacks of mail articles are formed for each deliverer. An unambiguous identification is printed onto each mail article. Subsequently, the mail articles which are to be carried out by a deliverer are divided into the pockets (206) of a case (204). The pockets 206 are arranged in accordance with the delivery route of a deliverer. On a screen 200, a graphical representation 204′ of the case 204 is shown, this representation showing each pocket 206 by an image 206′. On the screen 200, the images 112 of the mail articles 102 to be sorted are also shown successively. An operator allocates to each image 112 a picture 206′ of a pocket 206. As a result, each mail article 102 is allocated to one pocket 206. A sorter 216 processes this information in order to sort the mail articles 102 in accordance with this specification for the pockets 206. These steps can be carried out for each mail article 102 or else only for those mail articles, the address of which could not be decoded automatically.

United States patent application publication US 2004/003446 A1 describes an assembly for sorting mail articles by means of a sorting system 10, a computer 12, a working database 14, and a second database 22. The assembly is connected to several external computers 18A, 18B, 18C, 20 via a communication network, e.g. the Internet. In the working database 14, addresses are stored. A user of an external computer 18A, 18B, 18C, 20 can add a new address or change an existing address. This user information is stored in the second database 22 and compared with the entries in the working database 14.

U.S. Pat. No. 4,921,107 describes a device and a method for sorting mail articles. There, the device has a singularizer, a screen, a data input station and a sorting device. An operator reads the address on the mail article and inputs a part of an address component, e.g. the first three letters of the last name. The operator performs this input either at a keyboard or at a voice input device. On the screen, valid addresses from an address database are displayed which are compatible with the user input, e.g. in which the last name of the receiver begins with the three letters input. The user selects the record which corresponds to the address.

U.S. Pat. No. 6,134,561 presents a device for “tracking receipt and internal delivery of items.” Records for the incoming items are set up in a database of a computer. Each record comprises an internal address and the delivery status of the item. The stored status of an item is displayed on a screen of a mobile device. The mobile device is connected to the computer. On this device, a user can input information about an item. For this purpose, a bar code scanner decodes a machine-readable identification on the item. Or the user inputs an identification. The user can input where an item has actually been delivered and the damage exhibited by the item. This status information is stored in the database.

United States patent application publication US 2002/0178168 A1 describes a method for finding the actual position of an employee of a company at the current minute in order to then deliver a mail article or a message to the specific employee.

### SUMMARY OF THE INVENTION

It is accordingly an object of the invention to provide a method and a device for controlling the transportation of an object to a receiving unit which overcome the above-mentioned disadvantages of the heretofore-known devices and methods of this general type and which provide for a device and a method which enable the transportation to be controlled even when the reader is not capable of decoding the receiver identification on an object unambiguously.

With the foregoing and other objects in view there is provided, in accordance with the invention, a device for controlling a transportation of an object, the object having a receiver identification of a designated receiver of the object, the device comprising:
a computer-available allocation table, the allocation table comprising in each case one record with an identification of a receiver for a set of possible receivers, and each record of the allocation table additionally including a code of a receiving unit for an object;
an image recording device configured to generate a computer-available image showing the receiver identification; and
a reader connected to said image recording device and configured to automatically decode the receiver identification on a respective object by using an image from said image recording device;
a data-processing device connected to said image recording device and to said reader, said data-processing device having an input device and an output device;
said data-processing device being configured to:
   identify and select at least one record from the allocation table by using a decoding result from said reader; and
   output an entry of the selected record on the output device in a form perceptible by a person, the entry thus output identifying the receiving unit, the code of which is composed of the selected record;
   generate a computer-available selection list having each receiver identification of an identified record;
   output the generated selection list on said output device in a form perceptible by a person;
   detect a selection from the selection list, received from said input device;
   determine which receiver identification has been selected; and
   output a receiving unit identification with the identification of the receiving unit whose code belongs to the record of the receiver whose receiving identification has been selected.

The device according to the solution and the method according to the solution are arranged for controlling the transportation of an object. The object is provided with an identification of a receiver of the object.

The device according to the invention comprises:

an image recording device,

a reader,

a computer-available allocation table,

a data processing device with an output device and an input device.

The image recording device is arranged for generating a computer-available image in such a manner that the image indicates the receiver identification.

The reader is arranged for decoding the receiver identification by using an image from the image recording device.

The allocation table comprises, for a set of possible receivers, in each case one record with an identification of the receiver and a code of a receiving unit for an object.

The data-processing device is arranged for selecting a record in the allocation table by using a decoding result from the reader and outputting the receiving unit code of this record on the output device in a form perceptible by a person.

It is possible that the reader is not able to decode the receiver identification on an object unambiguously. For example, the receiver identification has been applied to the object by handwriting.

The embodiment according to the solution is provided particularly for this case. At least one record in the allocation table is identified, for which purpose the decoding result from the reader is used—preferably each record, the receiver identification of which is compatible with the decoding result. A selection list is generated. This selection list comprises the receiver identifications which belong to the records identified. The selection list is output in a form perceptible by a person on the output device. It is automatically detected which receiver identification has been selected in this selection list. This selection had been performed with the aid of an input device, e.g. a DP mouse or a keyboard or a contact-sensitive screen. The selected receiver identification belongs to an identified record. The receiving unit code of this record is output.

The invention obviates the requirement that a worker has to search through an allocation table which is present in paper-bound form in order to find the correct receiving unit for an object.

Furthermore, the invention renders superfluous that each receiving unit is provided with information relating to a receiver. Instead, the invention enables the correlation of a receiver with a receiving unit to be changed rapidly without having to perform a change at a receiving unit.

Thanks to the invention, the object of finding a receiving unit for the object is largely automated. In particular, the correct receiving unit is found automatically in as far as the receiver identifications on the object can be decoded automatically.

The embodiment according to the solution enables the transportation of the object to be controlled even when the reader does not produce an unambiguous decoding result or the decoding result is associated with great uncertainty. A preselection among the receiver identifications still fitting is performed automatically.

The image recording device can preferably generate an image of an object which is lying on a support area. This embodiment enables the device according to the solution to be used also for those objects which in each case have a significant extent in all three directions, that is to say, e.g. also for packets and not only for flat letters. The object is placed on the support area and, after a start signal, the image recording device generates the at least one image. This embodiment saves a transport device which transports the object past the image recording device. Furthermore, this embodiment enables a flat camera to be used instead of a cellular camera. This flat camera generates an image of a two-dimensional area of the surface of the object.

The device preferably comprises an optical pointing device. This optical pointing device marks by means of a light ray a point of such a surface of the object which points towards the image recording device. The object can be positioned in such a manner that this light ray marks a point in the address field on the object. This embodiment makes it easier for the reading device to find the receiver identification on the surface and thus also facilitates finding of the “region of interest” (ROI) and distinguishing the receiver identification from other information on the object, e.g. a sender identification or information relating to the transportation of the object.

With the above and other objects in view there is also provided, in accordance with the invention, a method for controlling the transportation of an object (Ma), the object (Ma) being provided with an identification (Add) of a receiver of the object (Ma), a computer-available allocation table (AT) being used, the allocation table (AT) in each case comprising a record with an identification of the receiver for a set of possible receivers, each record of the allocation table (AT) additionally comprising a code of a receiving unit (A2, C3, B4) for an object (Ma). The method comprises the following steps:

a computer-available image (Img) of the object (Ma) is generated in such a manner that the image shows the receiver identification (Add),

by using this image, the receiver identification (Add) on the object (Ma) is decoded,

by using the decoding result with the receiver identification of the object (Ma), a record of the allocation table (AT) is selected and

an entry (B4) of this selected record is output on an output device (4) in a form perceptible by a person,

the entry (B4) output identifying the receiving unit (A2, C3, D4), the code of which is composed of the selected record,

characterized in that,

by using the decoding result, at least one record of the allocation table (AT) is identified automatically,

a computer-available selection list (CL) is generated, the selection list (CL) comprising each receiver identification of an identified record,

the generated selection list (CL) is output on the output device (4) in a form perceptible by a person,

a selection from the selection list (CL), performed with the aid of an input device (5), is detected,

it is determined which receiver identification (Add) is selected as a result, and

as receiving unit identification, the identification of such a receiving unit (B4) is output, the code of which belongs to the record, the receiver identification (Add) of which is selected.

Other features which are considered as characteristic for the invention are set forth in the appended claims.

Although the invention is illustrated and described herein as embodied in a device and method for controlling the transportation of an object to a receiving unit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The sole FIGURE of the drawing illustrates a device and a workflow according to an exemplary embodiment of the invention.

### DETAILED DESCRIPTION OF THE INVENTION

In the exemplary embodiment, the invention is used for distributing mail articles to mail boxes of a mail box system. The mail box system is located, for example, in the mail room of a company or else of a post office.

The FIGURE illustrates the device according to the exemplary embodiment. It shows a mail box system MBS having a plurality or multiplicity of mail boxes for mail articles. Each mail box has a unique code which distinguishes the respective mail box unambiguously from all other mail boxes of the mail box system MBS.

A non-illustrated data memory stores a computer-available allocation table AT, which defines which mail box is allocated to which receiver. This allocation table AT comprises two columns: one column for the mail boxes of the mail box system MBS and one column for the receivers to whom these mail boxes are allocated. Each row stands for one mail box and one receiver who is allocated to this mail box. It is possible that a number of rows stand for the same mail box because several receivers are allocated to one mail box. For example, several receivers share one mail box or one receiver has a number of position designations or one receiver has taken over a mail box from another receiver.

If the invention is used in a post office, a receiver is identified by the house address (name, street, house number, zip code, city) or by a mail box address (name, mail box, zip code, city). Mail articles which are identified with the house address should also be sent to the mail box address.

If the invention is used in the mail department or a mail room of a company, each receiver is identified by a company address (name, designation of department within the company) or by an internal address. A receiver can have a number of company addresses, e.g. designation of department and area of operation, in as much as they should still receive mail articles to an earlier company address.

In the exemplary embodiment, the device also comprises:

a workstation computer 3 with a data input station 5 and a screen device 4;

a scanner 1; and

an OCR unit 2 with read access to the allocation table.

Both the workstation computer 3 and the OCR unit 2 have at least temporarily read access to the allocation table AT. The workstation computer 3 acts as the data processing device.

The scanner 1 is preferably constructed as a desktop scanner, i.e. stands on a table T or any other base. The scanner 1 comprises a light source LS and a camera 6. Because the scanner 1 is mounted to be stationary, the light source LS illuminates a mail article always at the same angle. The light source LS preferably projects a positioning aid PA, e.g. a reticle or a rectangle onto the table T. For an image of a mail article Ma to be generated, the mail article Ma is placed on the table T in such a manner that the mail article Ma has a certain position with respect to the positioning aid PA, e.g. that the reticle is projected centrally onto the address information Add with which the mail article is provided. The information relating to the receiver address points upward. A start signal is generated, e.g. by an operator or by a switch being triggered automatically.

The camera 1 generates a computer-available image IMG, preferably a digital image, of the mail article Ma. This image IMG shows the address information Add for the receiver of the mail article Ma.

The image Img is transmitted to the OCR unit 2. The OCR unit 2 evaluates the image Img. During this process, the OCR unit 2 locates the receiver identification Add in the image Img and decodes this receiver identification.

The OCR unit 2 compares this decoded information with the allocation table AT and, in doing so, generates candidates. These candidates form a computer-available candidate list CL. Each candidate comprises the information relating to a receiver, which information is contained in one row of the allocation table AT. For example, each candidate is a reference on such a row.

The OCR unit 2 preferably generates for each candidate in each case one consistency figure which is a degree of the consistency between the result of the decoding and the receiver identification Add in the allocation table AT. The OCR unit 2 selects as candidates each such row of the allocation table AT, the consistency figure of which is above a predetermined consistency barrier. The OCR unit 2 transmits the candidate list CL to the workstation computer 3.

If the OCR unit 2 has not determined a candidate, that is to say all consistency figures are below the consistency threshold, the workstation computer 3, in one embodiment, outputs a corresponding error message. The error message comprises the statement that the receiver address could not be decoded automatically.

In another embodiment, an input form having a number of fields is displayed on the screen device 4 of the workstation computer 3. The user enters a character sequence which he was able to read on the mail article Ps. For example, the user enters the first letters of the last name. The receiver addresses, the last names of which begin with this character sequence, are selected automatically from the allocation table AT.

This other embodiment is also used when the scanner 1 cannot generate an image Img of the mail article Ma, for example because the mail article is a parcel and does not fit between the camera 1 and the table T.

If the OCR unit 2 has determined a number of candidates and transmitted them to the workstation computer 3, the workstation computer 3 displays these candidates in a suitable manner on the screen device 4. The mail article Ma itself is still lying on the table T. In one embodiment, the candidates are displayed on the screen device 4 in the form of a selection list. A user selects an alternative offered, that is to say a candidate in the selection list, with the aid of the data input station 5. For example, the screen device 4 is arranged to be touch sensitive and the user touches the screen device 4 in an area which belongs to a candidate displayed. Or the data input station 5 comprises a keyboard and/or a DP mouse and the user, with the aid of the keyboard or of the DP mouse, selects an alternative offered. For this purpose, the user looks at the mail article Ma on the table T.

In the illustrated example, the OCR unit 2 has generated a candidate list CL which comprises the two candidates Reel and Rec3. The workstation computer 3 generates a selection list which comprises these two candidates Rec1 and Rec3 and displays this selection list on the screen device 4. The user compares these two candidates with the receiver identification Add on the mail article Ma and thereupon selects the candidate Rec3. This is shown by means of an oval around Rec3 in the FIGURE.

Even when the OCR unit 2 has determined exactly one candidate, this one candidate is displayed on the screen device 4 in one embodiment. The user confirms that this one candidate really corresponds to the receiver identification Add on the mail article Ma.

In the example of the FIGURE, the allocation table AT allocates the mail box B4 of the mail box system MBS to the receiver Rec3. The mail article Ma is brought into this mail box B4.

1. A device for controlling a transportation of an object, the object having a receiver identification of a designated receiver of the object, the device comprising:
a computer-available allocation table, the allocation table comprising in each case one record with an identification of a receiver for a set of possible receivers, and each record of the allocation table additionally including a code of a receiving unit for an object;
an image recording device configured to generate a computer-available image showing the receiver identification; and
a reader connected to said image recording device and configured to automatically decode the receiver identification on a respective object by using an image from said image recording device;
a data-processing device connected to said image recording device and to said reader, said data-processing device having an input device and an output device;
said data-processing device being configured to:
identify and select at least one record from the allocation table by using a decoding result from said reader; and
output an entry of the selected record on the output device in a form perceptible by a person, the entry thus output identifying the receiving unit, the code of which is composed of the selected record;
generate a computer-available selection list having each receiver identification of an identified record;
output the generated selection list on said output device in a form perceptible by a person;
detect a selection from the selection list, received from said input device;
determine which receiver identification has been selected; and
output a receiving unit identification with the identification of the receiving unit whose code belongs to the record of the receiver whose receiving identification has been selected.

2. The device according to claim 1, which comprises a support surface, and wherein said image recording device is disposed to enable said image recording device to generate an image of an object lying on said support surface.

3. The device according to claim 1, which further comprises an optical pointing device disposed for marking a point of a surface, facing towards said image recording device, of the object optically with a light ray; and
wherein said reader is configured for evaluating, during the decoding of the receiver identification, an area of the image showing the point marked by said pointing device.

4. A method for controlling a transportation of an object, the object being provided with an identification of a receiver of the object, the method which comprises:
providing a computer-available allocation table, the allocation table in each case comprising a record with an identification of the receiver for a set of possible receivers, and each record of the allocation table additionally including a code of a receiving unit for an object;
generating a computer-available image of the object, the image showing the receiver identification;
decoding the receiver identification on the object with the aid of the image;
automatically identifying at least one record of the allocation table by using the decoding result;
generating a computer-available selection list, the selection list comprising each receiver identification of an identified record and outputting an entry of the selected record on an output device in a form perceptible by a person, the output of the entry identifying the receiving unit, the code of which is composed of the selected record;
detecting a selection from the selection list, input via an input device; and
determining which receiver identification is selected as a result, and outputting, as receiving unit identification, the identification of such a receiving unit, the code of which belongs to the record, the receiver identification of which has been selected.

5. The method according to claim 4, which comprises placing the object onto a support surface and generating the image of the object lying on the support surface.

6. The method according to claim 4, which comprises:
optically marking a point on a surface, facing towards the image recording device, with a light ray; and
during the decoding of the receiver identification, evaluating an area of the image showing the point marked.
